(19) United States
(12) Patent Application Publication
(10) Pub. No.: US 2021/0283863 A1
(43) Pub. Date: Sep. 16, 2021

(54) Architecture-, Geometry-, and Microstructure-Controlled Processing of Carbon Fibers and Nanofibers via Pyrolysis of Multicomponent Hot-Drawn Precursors

(71) Applicant: THE TEXAS A&M UNIVERSITY SYSTEM, College Station, TX (US)

(72) Inventors: Mohammad Naraghi, Cypress, TX (US); James G. Boyd, IV, Brenham, TX (US); Jizhe Cai, College Station, TX (US); Yijun Chen, College Station, TX (US); John Michael Beckerdite, College Station, TX (US)

(21) Appl. No.: 17/259,974

(22) PCT Filed: Aug. 1, 2019
(86) PCT No.: PCT/US2019/044579

§ 371 Date: Jan. 13, 2021

Related U.S. Application Data
(60) Provisional application No. 62/714,126, filed on Aug. 3, 2018.
(60) Provisional application No. 62/775,495, filed on Dec. 5, 2018.

(51) Int. Cl. B29C 70/02; D01D 5/00; D01D 5/24; D01F 1/08; D01F 9/22; B29C 63/00; B29C 70/34; F16L 55/165

(52) U.S. Cl. CPC B29C 70/025; D01D 5/0007; D01D 5/24; D01F 1/08; B29K 2309/08; B29C 63/0073; B29C 63/0004; B29C 70/342; F16L 55/1656; D01F 9/22

(57) ABSTRACT

A curing process includes providing a hybrid material comprising a conductive filler in contact with a thermosetting resin. In addition, the curing process includes passing an electric current through the hybrid material to provide Joule heating until a temperature of the hybrid material reaches a temperature above a curing temperature of the thermosetting resin.

### CROSS-REFERENCE TO RELATED APPLICATIONS

This application is a 35 U.S.C. § 371 national stage application of PCT/US2019/044579 filed Aug. 1, 2019, which claims benefit of U.S. provisional patent application Ser. No. 62/714,126 filed Aug. 3, 2018, and entitled “Architecture, Geometry, and Microstructure-Controlled Processing of Carbon Fibers and Nanofibers via Pyrolysis of Multicomponent Hot-Drawn Precursors,” and U.S. provisional patent application Ser. No. 62/775,495 filed Dec. 5, 2018, and entitled “Architecture, Geometry, and Microstructure-Controlled Processing of Carbon Fibers and Nanofibers via Pyrolysis of Multicomponent Hot-Drawn Precursors,” each of which is hereby incorporated herein by reference in its entirety for all purposes.

### STATEMENT REGARDING FEDERALLY SPONSORED RESEARCH OR DEVELOPMENT

This invention was made with government support under FA9550-15-1-0170 awarded by Air Force Office of Scientific Research and Department of Defense award number W911NF-18-1-0128. The government has certain rights in the invention.

### TECHNICAL FIELD

The present disclosure relates to hybrid materials or composites comprising a conductive filler and a thermosetting or thermoplastic resin, and to carbon nanofibers (CNF) and methods for producing same that can be utilized to provide the conductive filler.

### BACKGROUND

Carbon fibers (CFs) are primarily used as load bearing materials in structural components of aerospace and automotive applications due to their excellent specific strength and stiffness, lightweight and environmental resistance. There have recently been efforts to study the performance of this CFs as electrodes of batteries and supercapacitors. These studies often rely on inducing surface pores in CFs (activated CFs) to increase the specific surface area of the material to enhance the energy density of supercapacitors. For example, commercial CFs have been activated with potassium hydroxide (KOH), resulting in a 100 fold increase of specific area with no reduction in mechanical performance. However, the specific surface area of activated CFs was limited to 23 m²/g, which is a small fraction of what can be achieved in other carbon materials such as porous carbon nanofibers (CNF), hollow CNF, and carbon nanotube (CNT). Thus, although CFs remain an excellent choice for load bearing, they have not heretofore been demonstrated as promising materials for structural supercapacitor energy storage.

### SUMMARY

Herein disclosed is a curing process comprising: providing a hybrid material comprising a conductive filler in contact with a thermosetting resin; and passing an electric current through the hybrid material to provide Joule heating until a temperature of the hybrid material reaches a temperature above a curing temperature of the thermosetting resin.

Also disclosed herein is a process comprising: forming a plurality of precursor fibers, wherein the plurality of precursor fibers comprise a polymer; drawing the plurality of precursor fibers at a drawing temperature above room temperature; and subjecting the plurality of precursor fibers to a pyrolysis process after the drawing.

Further provided herein is a hybrid material comprising a conductive filler in contact with a thermosetting resin or a thermoplastic resin, wherein the thermosetting resin or the thermoplastic resin is in contact with a flexible fabric, and wherein the hybrid material comprises from about 0.1 to about 10 weight percent (wt %) of the conductive filler, wherein the hybrid material has a conductivity such that an electric current in a range of from about 0.1 to about 10 Amperes (A) can be passed through the hybrid material to provide Joule heating such that a temperature of the hybrid material reaches a temperature above a curing temperature of the thermosetting resin or a melting temperature of the thermoplastic resin whereby the thermosetting resin can be cured or the thermoplastic resin can be melted.

Further provided herein is a method of forming a cured in place pipe (CIPP) or a habitat from the hybrid material of this disclosure.

Also described herein is thermoforming of a hybrid material of this disclosure comprising the thermoplastic resin by Joule heating, whereby the thermoplastic resin is heated to a temperature above a melting point thereof, the hybrid material assumes a new shape, and, upon cooling of the thermoplastic resin below the melting point thereof, solidifies.

Further provided herein is a composite material comprising a thermoplastic material and a conductive filler selected from carbon fibers, carbon nanofibers (CNF), graphene particles, graphene nanoparticles, carbon black, metallic particles, metallic fibers, metallic meshes, or a combination thereof, whereby the thermoplastic material can be heated to a temperature above a melting temperature and/or a softening point thereof via Joule heating.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of the preferred embodiments of the disclosed processes, reference will now be made to the accompanying drawings in which:

FIG. 1 is a schematic of a composite layup, according to embodiments of this disclosure;

FIG. 2A is a schematic of an unbent CNF mat, according to embodiments of this disclosure;

FIG. 2B is a schematic of a folded CNF mat, according to embodiments of this disclosure;

FIG. 3A depicts a SEM image of the hollow carbon nanofibers (HCNF) with solid shell, as described in Example 1;

FIG. 3B depicts another SEM image of the HCNF with solid shell, as described in Example 1;

FIG. 3C depicts a SEM image of the HCNF with porous shell, as described in Example 1;

FIG. 3D depicts another SEM image of the HCNF with porous shell, as described in Example 1;

FIG. 3E shows Raman spectra of porous and solid shell HCNF of Example 1;

FIG. 4A shows the N² adsorption isotherms of CNF with solid and porous shells, as described in Example 1;

FIG. 4B is a pore size distribution plot for the solid and porous shell HCNF of Example 1;

FIG. 5A is a plot of representative stress-strain curves of CNF with solid and porous shells, as described in Example 1;

FIG. 5B is a bar graph of the average modulus of the solid shell and porous shell HCNF of Example 1;

FIG. 5C is a bar graph of the strength of the solid shell and porous shell HCNF of Example 1;

FIG. 5D is a bar graph of the strain to failure of the solid shell and porous shell HCNF of Example 1;

FIG. 6A shows SEM images of the fracture (failure) surface of the porous shell HCNF of Example 1;

FIG. 6B shows SEM images of the fracture (failure) surface of the solid shell HCNF of Example 1;

FIG. 6C is a schematic depiction of the cross section of the porous shell HCNF of Example 1;

FIG. 6D is a schematic depiction of the cross section of the solid shell HCNF of Example 1;

FIG. 7A is a SEM image of the fracture surface of the porous shell CNF after mechanical test, as described in Example 1;

FIG. 7B depicts a longitudinal cross section of porous shell CNF obtained through FIB etching in Example 1;

FIG. 7C depicts another longitudinal cross section of porous shell CNF obtained through FIB etching in Example 1;

FIG. 7D is a schematic for the Representative Volume Element (RVE) used in the finite element analysis of Example 1;

FIG. 8A is a plot of the strength reduction as a function of the aspect ratio (l/r) of the pores for the porous shell CNF of Example 1;

FIG. 8B is a plot of the strength reduction as a function of the pore shape (a/r) for the porous shell CNF of Example 1;

FIG. 8C is a plot of the strength reduction as a function of the porosity (%) for the porous shell CNF of Example 1;

FIG. 9 is a schematic of the VARTM setup of Example 2;

FIG. 10A is a schematic of the cured composite of Example 2;

FIG. 10B is a thermal image of the composite panel of Example 2 during the curing process thereof;

FIG. 11 is a plot of the curing length (m) with 5 kV power supply as a function of the sheet resistance Rₛ, as described in Example 3; and

FIG. 12 is a schematic of a CIPP process, according to embodiments of this disclosure.

### DETAILED DESCRIPTION

As previously described, although CFs remain an excellent choice for load bearing, they have not heretofore been demonstrated as promising materials for structural supercapacitor energy storage. One possible method of increasing the specific surface area while maintaining high strength is to reduce the diameter of CFs and also induce an interconnected network of internal and external pores in the material to dramatically increase the surface area of the pores. In this regard, various forms of CNF, such as porous CNF, hollow CNF, and activated CNF, have been used as electrodes in energy storage devices due to their excellent electrical conductivity, large specific surface area and good structural stability. While these efforts have been shown to effectively enhance energy storage functionality, the pores act as stress concentration sites and also reduce the effective load bearing area, which reduce the load bearing capability. Thus, there are two approaches to developing carbon-based structural energy materials. Firstly, one could begin with CFs with excellent mechanical properties and attempt to increase the specific surface area. Secondly, one could begin with porous CNF and attempt to increase the mechanical properties by controlling the porosity (e.g., the shape of the pores). Accordingly, a need exists for systems and methods of forming porous CNF, and for hybrid materials or “composites” comprising same.

Herein disclosed are composite or hybrid materials and methods of making such materials. In embodiments, the composite materials comprise CNF. The CNF can, in embodiments, be porous CNF. Via this disclosure, the architecture, geometry, and microstructure of the pores in porous CNF can be controlled via pyrolysis of multi-component hot-drawn precursor fibers. The loss of stiffness and strength due to pores in CNF has been studied (see, for example, Example 1), and the porosity of the CNF related to the processing method.

Also provided are a system and method for producing CNF, which can be utilized as a conductive filler of a hybrid material as described herein or for other purposes. Disclosed herein are: (1) a setup or apparatus to make precursor fibers, apply hot-drawing, add sacrificial polymers, and conduct pyrolysis, and (2) a procedure and operating parameters for fabricating CNF with controlled microstructure, geometry and architecture. In embodiments, the application of hot-drawing to precursor nanofibers with fillers, such as carbon nanotubes (CNTs) and/or sacrificial polymers, allows for controlling the microstructure, geometry and architecture of the CNF.

Electrospinning can be utilized to fabricate CNF, according to embodiments of this disclosure. In embodiments, any polymers which can form carbon structure through pyrolysis can be utilized as precursors in electrospinning to fabricate CNF according to this disclosure. For example, in embodiments, polymers such as, but not limited to, polyacrylonitrile (PAN), polyvinylidene fluoride (PVDF) and lignin can be used. PAN may be chosen, in applications, due to its excellent spinnability, low cost and high carbon yield. As detailed further hereinbelow, to increase the specific surface area of the resulting CNF, porous CNF can be made, in embodiments, by electrospinning a blend of polymer precursor and a sacrificial component. The sacrificial component can subsequently be removed either by a post treatment and/or can be decomposed during the pyrolysis to form pores. In embodiments, the sacrificial component comprises poly(methyl methacrylate) (PMMA), polystyrene (PS) and/or silicon dioxide (SiO₂). In embodiments, to further increase the specific surface area of the resulting CNF, a sacrificial core can be added to the fibers by coaxial electrospinning to make hollow CNF. In such embodiments, both internal and external surfaces of the hollow CNF can contribute to the specific surface area.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed herein. Because these ranges are continuous, they include every value between the minimum and maximum values. The endpoints of all ranges reciting the same characteristic or component are independently combinable and inclusive of the recited endpoint. Unless expressly indicated otherwise, the various numerical ranges specified in this application are approximations. The endpoints of all ranges directed to the same component or property are inclusive of the endpoint and independently combinable. The term “from more than 0 to an amount” means that the named component is present in some amount more than 0, and up to and including the higher named amount.

The terms “a,” “an,” and “the” do not denote a limitation of quantity, but rather denote the presence of at least one of the referenced items. As used herein the singular forms “a,” “an,” and “the” include plural referents.

As used herein, “combinations thereof” is inclusive of one or more of the recited elements, optionally together with a like element not recited, e.g., inclusive of a combination of one or more of the named components, optionally with one or more other components not specifically named that have essentially the same function. As used herein, the term “combination” is inclusive of blends, mixtures, alloys, reaction products, and the like.

Reference throughout the specification to “embodiments,” “another embodiment,” “other embodiments,” “some embodiments,” and so forth, means that a particular element (e.g., feature, structure, property, and/or characteristic) described in connection with the embodiment is included in at least embodiments described herein, and may or may not be present in other embodiments. In addition, it is to be understood that the described element(s) can be combined in any suitable manner in the various embodiments.

As used herein, the terms “inhibiting” or “reducing” or “preventing” or “avoiding” or any variation of these terms, include any measurable decrease or complete inhibition to achieve a desired result.

As used herein, the term “effective,” means adequate to accomplish a desired, expected, or intended result.

As used herein, the terms “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”) are inclusive or open-ended and do not exclude additional, unrecited elements or method steps.

Unless defined otherwise, technical and scientific terms used herein have the same meaning as is commonly understood by one of skill in the art.

Herein disclosed is a hybrid material (also referred to herein as a “composite” or “composite material”) and a method of making same. In embodiments, the hybrid material comprises a conductive filler in contact with a thermosetting resin or a thermoplastic resin. In embodiments, the thermosetting resin or the thermoplastic resin is in contact with (e.g., is distributed within) a flexible fabric. In embodiments, the hybrid material comprises from about 0.1 to about 10 weight percent (wt %) of the conductive filler. In embodiments, the hybrid material has a conductivity such that an electric current in a range of from about 0.1 to about 10 Amperes (A) can be passed through the hybrid material to provide Joule heating or resistive Joule heating such that a temperature of the hybrid material reaches a temperature above a curing temperature of the thermosetting resin or a melting temperature of the thermoplastic resin, whereby the thermosetting resin can be cured or the thermoplastic resin can be melted, respectively, to provide a cured material (also referred to herein as a “cured composite”) or a melted composite. As utilized herein, “curing” refers to the formation of chemical crosslinks within the uncured or partially uncured thermosetting resin, which can be in a liquid or flowable form, leading to the solidification.

In embodiments, the hybrid material exhibits a resistivity (which is the inverse of the conductivity) that is in a range of from about 1*10⁻⁵ to about 20*10⁻⁵ ohm-meter (Ω·m). In embodiments, the hybrid material has a sheet resistance in the range of from about 1 to about 20 ohms per square (Ω/sq). The conductive filler is incorporated into the hybrid material to render it conductive. The resistivity/conductivity of the hybrid material can be selected (e.g., the amount and/or type of conductive filler chosen) such that Joule heating or resistive Joule heating can be effected with a reasonable voltage and current.

In embodiments, the hybrid material of this disclosure comprises less than or equal to about 10 weight percent (wt %) of the conductive filler (e.g., CNF). In embodiments, the hybrid material comprises greater than, less than, or equal to about 0.1 weight percent (wt %) of the conductive filler (e.g., CNF).

The conductive filler can, in embodiments, be any material suitable to provide conductivity to the hybrid material such that a temperature thereof can be increased via Joule heating or resistive Joule heating. For example, in embodiments the conductive filler is selected from carbon fibers, carbon nanofibers (CNF), graphene particles, graphene nanoparticles, carbon black, metallic particles, metallic fibers, metallic meshes, or a combination thereof. In embodiments, for example, the conductive filler comprises carbon nanofibers (CNF).

Also disclosed herein are CNF, and a system and method for producing same. In embodiments, the CNF utilized in the hybrid material of this disclosure are produced via a system and method as detailed herein. As detailed hereinbelow, the porosity, architecture, geometry, and/or microstructure of the CNF can be tailored, in embodiments, by controlling processing during production of the CNF. In embodiments, for example and as detailed further hereinbelow, the CNF can be obtained by: forming a plurality of precursor fibers via electrospinning, wherein the plurality of precursor fibers comprise a polymer; drawing the plurality of precursor fibers at a drawing temperature; and subjecting the plurality of precursor fibers to a pyrolysis process at a pyrolysis temperature after the drawing, whereby the polymer carbonizes to provide the CNF. In embodiments, the drawing temperature is greater than or equal to room temperature (e.g., greater than or equal to the glass transition temperature (T_{g}) of the precursor fibers). In embodiments, the pyrolysis temperature is greater than the glass transition temperature T_{g} of the precursor fibers. Also disclosed herein are carbon fibers and carbon nanofibers (CNF) fabricated via such a pyrolysis process. In embodiments, the CNF have an aspect ratio of greater than or equal to about 10,000, and/or a diameter of less than or equal to about 500 nm (0.5 millionth of a meter).

As noted above, in embodiments, the process of producing CNF comprises: forming a plurality of precursor fibers, wherein the plurality of precursor fibers comprise a polymer; drawing the plurality of precursor fibers at a drawing temperature above room temperature; and subjecting the plurality of precursor fibers to a pyrolysis process after the drawing. In embodiments, subjecting the plurality of precursor fibers to a pyrolysis process after the drawing comprises subjecting the precursor fibers to a pyrolysis temperature of greater than or equal to about 1400° C. In embodiments, the drawing temperature is less than the pyrolysis temperature of the pyrolysis process and greater than or equal to the glass transition temperature (T_{g}) of the precursor fibers. In embodiment, the glass transition temperature (T_{g}) of the precursor fibers is in a range of from about 60° C. to about 230° C., from about 70° C. to about 230° C., or from about 80° C. to about 230° C. In embodiments, the drawing temperature is in a range of from about 90° C. to about 230° C., from about 100° C. to about 230° C., or from about 110° C. to about 230° C.

The precursor fibers can be formed by any method known to those of skill in the art. In embodiments, forming the plurality of precursor fibers comprises electrospinning of the polymer. The polymer can comprise polyacrylonitrile (PAN), pitch, or polyvinylidene fluoride (PVDF), or a combination thereof, in embodiments. In embodiments, the precursor fibers comprise the polymer and another polymer, wherein the second polymer decomposes during the pyrolysis process to provide pores in the CNF. In embodiments, the another polymer comprises polymethylmethacrylate (PMMA), or another polymer which decomposes into volatile species during carbonization, or a combination thereof. In such embodiments, the precursor fibers can comprise a continuous phase of the polymer with a discontinuous phase (e.g., islands) of the another polymer therein.

In embodiments, the subjecting of the plurality of precursor fibers to the pyrolysis process after the drawing results in the formation of a plurality of carbon nanofibers (CNF).

The conversion of polymers into carbon (pyrolysis) has been known for over a century. In embodiments, (1) the precursor fibers of this disclosure are fabricated via electrospinning to result in fibers which have diameters in a range of from about 200 nm to about 1 micron. In embodiments, (2) the precursor fibers can, in embodiments, have graphitic inclusions, such as, without limitation, carbon nanotubes (CNTs) and/or graphene, to enhance the microstructure of the post-pyrolysis fibers. Novel aspects of the herein disclosed method of producing CNF include the combination of the following: (3) prior to pyrolysis, the precursor fibers are hot-drawn; hot drawing can enhance the strength of the CNF resulting from pyrolysis of the hot-drawn fibers, and additionally may stretch the sacrificial phase (e.g., PMMA) and upon carbonization lead to higher surface area; (4) the precursor fibers can, in embodiments, include other components, such as, without limitation, a sacrificial polymer as inter- and intra-fiber components; the use of such other components can be utilized to control the adhesion between CNF and the architecture of the CNF; (5) carbonization during pyrolysis can be effected at a temperature of greater than or equal to about 1400° C. The CNF production process of this disclosure can, in embodiments, provide CNF a strength (e.g., as measured by the single fiber tension tests) of as high as 10 GPa. The use of hot drawing (step (3)) in combination with the inclusion of other components (e.g., the inclusion of carbon nanotubes (CNTs) at step (4) and/or graphitic inclusions at step (2)) and/or the high temperature pyrolysis of step (5) can be utilized to provide a platform to enhance the microstructure of the resulting CNF, which can allow control of the architecture of the CNF. For example, the CNF can have an architecture that includes enhanced porosity and/or graphitization relative to CNF made in the absence of hot drawing at step (3), the utilization of graphitic inclusions at step (2), the incorporation of the other component(s) at step (4), and/or pyrolysis at a high temperature of step (5). In embodiments, the process utilized to produce the CNF can include activation of the fibers via KOH treatment to enhance the specific surface area of the fibers. The herein disclosed CNF production method can provide scalability. The hot drawing step (3) can align the precursor fibers, increase the length and surface area of the fibers, and thus further enhance the strength of the resulting CNF relative to CNF that are produced without hot drawing of the precursor fibers.

By controlling the processing parameters (e.g., hot drawing temperature of step (3), the graphitic inclusions at step (2), the other components incorporated at step (4), and/or the high pyrolysis temperature at step (5)), CNF having a variety of forms, including microstructure, shape and geometry, can be formed. In embodiments, the CNF comprise: (a) highly graphitic CNF, (b) wavy CNF, (c) porous CNF with high porosity and/or (d) hollow CNF with extremely thin walls. In embodiments, the CNF comprise (a) highly graphitic CNF. As utilized herein, (a) highly graphitic CNF comprise a greater amount of graphite than non-graphitic CNF, for example, a graphitic content which can reach nearly 100%. Such highly graphitic CNF can be formed by carbonization at temperatures exceeding 1700° C. The high degree of graphitization of such highly graphitic CNF can provide for higher electrical conductivity than non-highly graphitic CNF. In embodiments, the CNF comprise (b) wavy CNF. As utilized herein, (b) wavy CNF comprise a greater waviness than non-wavy CNF, for example, a waviness (as defined by wavelength of a fiber which is sinusoidal, or the pitch of a helical fiber) of less than or equal to about 2 μm. Such (b) wavy CNF can be formed by carbonizing PAN nanofibers inside another matrix (such as PMMA) which shrinks during carbonization. The PAN nanofibers will accommodate the shrinkage of the PMMA via buckling, thereby, leading to the formation of the wavy fibers. Waviness of the (b) wavy CNF can increase the deformability of the wavy CNF relative to non-wavy CNF. In embodiments, the CNF comprise (c) porous CNF. As utilized herein, (c) porous CNF comprise a greater porosity than non-porous CNF. For example, (c) porous CNF can have a porosity (as determined by gas absorption techniques, mainly Brunauer-Emmett-Teller (BET)) of greater than or equal to about 800 m²/g (meter squared of total surface area per gram of the material). Such (c) porous CNF can be formed by wet chemical etching (activation). In embodiments, the CNF comprise (d) hollow CNF with thin walls. As utilized herein, (d) thin walled hollow CNF comprise a wall thickness that is less than the diameter of non-thin walled (i.e., solid) CNF. For example, (d) thin walled hollow CNF can have a wall thickness (as determined by Scanning Electron Microscopy Imaging) of less than or equal to about 200 nm. Such (d) thin walled hollow CNF can be formed by using core-shell fibers comprised of PMMA cores and PAN shells as precursors of CNF, subject them to hot-drawing to reduce the thickness of the skin, followed by carbonization. The high porosity of the (c) porous CNF and/or the thin walls of the (d) thin walled, hollow CNF can provide ample free surfaces for the storage of energy. In embodiments, the system and method of producing CNF, as disclosed herein, enables the production of a variety of CNF forms, as described above, with scalable production.

In embodiments, the operating parameters for the CNF production process are controlled to provide a desired value for one or more controllable property of the resulting CNF. For example, the controllable properties include the aspect ratio, the mechanical strength, the electrical conductivity, the surface area, or a combination thereof of the CNF. In embodiments, the CNF produced via the herein disclosed process have a high aspect ratio. For example, in embodiments, the CNF are nearly continuous and/or have an aspect ratio that is greater than or equal to about 1,000 or 10,000. In embodiments, the CNF have a high mechanical strength, as determined by single fiber tension tests. For example, in embodiments, the CNF have a mechanical strength greater than or equal to about 2, 3, 4, 5, 6, 7, 8, 9, or 10 GPa. In embodiments, the CNF have a high electrical conductivity. For example, in embodiments, the CNF have an electrical conductivity of greater than or equal to about 10⁴ S/m. In embodiments, the CNF have a high surface area, as determined for example, via BET. In embodiments, the CNF have a Brunauer-Emmett-Teller (BET) surface area of greater than or equal to about 300 m²/g.

Also disclosed herein are products comprising the herein disclosed CNF. For example, without limitation, in embodiments, CNF as disclosed herein can be used (i) to enhance the mechanical properties of composites and 3D printed parts, including strength, toughness and modulus; (ii) to store energy, for example via hollow/porous CNF, as electrodes of batteries and supercapacitors, for example; (iii) to impart electrical conductivity to composites, for instance for use in EMI shielding, CIPP, habitats, and lightning strike protection; and/or (iv) to sense environmental stimuli, such as gas and strain.

In embodiments, compared to conventional carbon fibers, the CNF of this disclosure are substantially thinner (e.g., 5 to 30 times thinner). For example, in embodiments, CNF of this disclosure have a diameter of less than or equal to about 500, 400, 300, 200, or 100 nm. As a result, the herein disclosed CNF can be stronger and have higher specific surface area than conventionally produced CNF (e.g., produced without hot drawing of step (3), without inclusion of other components of optional step (4), and/or without the graphitic inclusions of step (2)). Without limitation, such traits can be particularly useful in composites and energy storage devices. Compared to other high aspect ratio nanoscale fillers, such as CNTs, an advantage of the herein disclosed CNF may be the scalability of production. The herein disclosed CNF production process can, in embodiments, enable production of CNF at price points that are orders of magnitude cheaper than CNTs having similar properties.

In embodiments, the conductive filler of the hybrid material comprises a network of the CNF. For example, the network of CNF can be in the form of a CNF mat or a percolated network of the CNF. As utilized herein, a CNF mat comprises a non-intertwined mat of individual CNF and can be formed by carbonizing a mat of electrospun PAN nanofibers. As utilized herein, since the CNF are nearly continuous, the mats formed via this approach are inherently a percolated network.

In embodiments, the network of the CNF is embedded in the thermosetting resin or the thermoplastic resin. In embodiments, the network of CNF comprises a CNF mat. As described in Example 2 hereinbelow, the CNF mat or other network of CNF can be sandwiched between a first layer of the flexible fabric and a second layer of the flexible fabric. In embodiments, the first layer of fabric, the second layer of the fabric, or both the first layer of fabric and the second layer of fabric comprise (e.g., distributed therein) the thermosetting resin or the thermoplastic resin.

In embodiments, the hybrid material comprises a cured in place pipe (CIPP) liner comprising a liner of the flexible fabric impregnated with the thermosetting resin and further comprising the conductive filler. In such applications, the hybrid material can be utilized for CIPP applications.

In embodiments, the resin of the hybrid material comprises a thermosetting resin. Any thermosetting resin known to those of skill in the art can be utilized, in embodiments. In particular embodiments, the thermosetting resin comprises an epoxy resin, a vinyl ester resin, an unsaturated polyester resin, or a combination thereof. In embodiments, the resin of the hybrid material comprises a thermoplastic resin. Any thermoplastic resin known to those of skill in the art can be utilized, in embodiments. In particular embodiments, the thermoplastic resin comprises an acrylate, a nylon, a polyolefin, polystyrene, polyether ether ketone, polyvinyl chloride, polyphenylene sulfide, or a combination or derivative thereof.

In embodiments, a hybrid material of this disclosure further comprises a fabric. The fabric can be a flexible fabric. Any fabric can be utilized, so long as the fabric can be subjected to the elevated temperatures to which it will be subjected during the curing of the thermosetting resin or the melting of the thermoplastic resin, respectively. As utilized herein, a “flexible” fabric is a fabric that can be stretched (e.g., along a length or a width thereof) by at least 5, 10, or 15% from an initial length thereof. In embodiments, the flexible fabric has a melting temperature greater than the curing temperature of the thermosetting resin and/or the melting temperature of the thermoplastic resin. In embodiments, the flexible fabric comprises fiberglass, natural fibers, synthetic fibers, or a combination thereof.

Also disclosed herein is a method of forming a hybrid material or composite according to this disclosure. In embodiments, the method of forming the hybrid material comprises: forming a network of the CNF, and contacting the network of the CNF with a thermosetting or thermoplastic resin to form the hybrid material. In embodiments, the CNF from which the network of CNF is formed have the properties noted hereinabove and/or are produced via the herein disclosed CNF production process. In embodiments, the hybrid material has the properties recited hereinabove.

The method of forming the hybrid material can further comprise contacting the network of the CNF with a thermosetting resin or with a thermoplastic resin to form the hybrid material.

In embodiments, as noted above, the thermosetting or thermoplastic resin can be distributed within a flexible fabric of the hybrid material. Accordingly, in such embodiments, the method can further comprise forming the flexible fabric having the thermosetting or thermoplastic resin distributed therein. Such flexible fabric having the thermosetting or thermoplastic resin distributed therein can be formed by any suitable means known to those of skill in the art. In embodiments, the flexible fabric having the thermosetting or thermoplastic resin distributed therein can be formed by vacuum assisted resin transfer molding (VARTM). VARTM can comprise, for example, a felt impregnated with a thermosetting epoxy system.

In embodiments, the thermosetting resin is distributed within a cured in place pipe (CIPP) liner. In embodiments, the CIPP liner comprises a fabric liner impregnated with the thermosetting resin. In such embodiments, the thermosetting resin can comprise an epoxy resin, a vinyl ester resin, an unsaturated polyester resin, or a combination thereof.

In embodiments, contacting the network of the conductive filler (e.g., network of CNF) with the thermosetting or thermoplastic resin to form the hybrid material further comprises embedding the network of the CNF in the thermosetting or thermoplastic resin. As noted above, the network of the conductive filler can comprise a network of CNF. In embodiments, the network of CNF comprises a CNF mat. In such embodiments, the method of forming the hybrid material can further comprise forming a CNF mat as described hereinabove. In embodiments, contacting the network of the conductive filler (e.g., the network of CNF) with the thermosetting resin or the thermoplastic resin to form the hybrid material comprises sandwiching the network of the conductive filler (e.g., the CNF mat) between a first fabric layer and a second fabric layer to form a layup, wherein a side of the first fabric layer proximate the network of conductive filler (e.g., the CNF mat), a side of the second fabric layer proximate the network of the conductive filler (e.g., the CNF mat), or both comprise the thermosetting resin or the thermoplastic resin. In embodiments, as noted above, the resin can be infused into the fabric via VARTM. The resin infused fabric can be dry during the formation of the layup.

Also disclosed herein are a method of curing a thermosetting material and a method of melting a thermoplastic material. The method comprises forming or providing a hybrid material as described hereinabove and passing an electric current through the hybrid material. In embodiments, the hybrid material comprises the thermosetting resin, and passing the electric current through the hybrid material is effected such that Joule heating or resistive Joule heating heats the hybrid material to a temperature of greater than or equal to the curing temperature of the thermosetting resin and optionally maintaining the elevated temperature until the thermosetting resin is thermoset. In embodiments, the curing temperature is in the range of from about 100° C. to about 300° C., from about 100° C. to about 230° C. from about 100° C. to about 160° C.

In embodiments, the hybrid material comprises the thermoplastic resin, and passing the electric current through the hybrid material is effected such that Joule heating or resistive Joule heating heats the hybrid material to a temperature of greater than or equal to the melting temperature of the thermoplastic resin and optionally maintaining the elevated temperature until the thermoplastic polymer is melted. In embodiments, the melting temperature is in the range of from about 100° C. to about 300° C., from about 100° C. to about 230° C. from about 100° C. to about 160° C.

In embodiments, passing the electric current through the hybrid material comprises providing an electric current of less than or equal to about 1, 5 or 10 Amperes (A). In embodiments, a voltage applied to the hybrid material during the curing and/or melting process is in a range of from about 10 to about 200 volts (V) per meter length of the hybrid material.

In embodiments, the method of curing the thermosetting material or the method of melting the thermoplastic material can be utilized to produce a cured in place pipe (CIPP) or a habitat.

Also disclosed herein are a curing process for curing a thermosetting polymer in a hybrid material of this disclosure comprising the thermosetting resin and a melting process for melting a thermoplastic resin in a hybrid material of this disclosure comprising the thermoplastic resin. In embodiments, the method comprises: providing a hybrid material comprising a conductive filler in contact with a thermosetting resin; and passing an electric current through the hybrid material to provide Joule heating or resistive Joule heating until a temperature of the hybrid material reaches a temperature above a curing temperature of the thermosetting resin. In embodiments, the method comprises: providing a hybrid material comprising a conductive filler in contact with a thermoplastic resin; and passing an electric current through the hybrid material to provide Joule heating or resistive Joule heating until a temperature of the hybrid material reaches a temperature above a melting temperature of the thermoplastic resin.

In some such embodiments, the conductive filler comprises CNF. In such embodiments, the method can further comprise forming the CNF. Forming the CNF can be effected as described hereinabove. For example, in summary here, in embodiments, forming the CNF further comprises: forming a plurality of precursor fibers, wherein the plurality of precursor fibers comprise a polymer, drawing the plurality of precursor fibers at a drawing temperature, wherein the drawing temperature is above room temperature; and subjecting the plurality of precursor fibers to a pyrolysis process after the drawing, whereby the polymer carbonizes to provide the CNF. Other details of the CNF production can be as detailed hereinabove.

Herein disclosed are hybrid materials comprising an electrically conductive network (e.g., of CNF, either in the form of continuous CNF fiber mat or percolated network of CNF) that can be embedded into a thermoset polymer, a thermoplastic polymer, or their composites with other types of fibers, to form the hybrid material. Electric current can be passed through the hybrid material, as a means to heat it up (e.g., via Joule heating or resistive Joule heating). The heating can be used, for example, to temporarily soften the hybrid material (e.g., in the case of the thermoplastic resin) and to reform it via other means such as mechanical force, or to cure the hybrid material (e.g., in case of a thermosetting resin). The thermosetting polymers may include, for example, an epoxy resin system, a vinyl ester resin system, etc., but are not limited thereto. In embodiments, the hybrid material comprises a relatively small amount of CNF. Specifically, in some embodiments, the hybrid material comprises less than about 10 wt % of the conductive filler (e.g., CNF), such as, for example, less than or equal to about 0.1 wt % or less than or equal to 0.05 wt %. The herein disclosed hybrid material can be utilized for “cure on demand” applications, such as, without limitation CIPP. Use of the herein disclosed hybrid material can allow for curing of a CIPP liner internally and efficiently, in embodiments.

The conductive filler can comprise CNF, which, in embodiments, can be formed as detailed herein. In embodiments, utilizing CNF as described herein in the hybrid material reduces curing cost by reducing curing cost, equipment, and/or labor.

Thus, in embodiments, herein disclosed is a hybrid material, such as a liner used for CIPP, which includes a CNT mesh and a thermoset to achieve a desired range of electrical conductivities, as mentioned above, in which the conductive filler is used to induce Joule heating, as a means to cure the thermoset. Also disclosed herein is a hybrid material, such as a liner used for CIPP which includes a conductive filler (such as a metallic mesh or a percolated mesh of conductive fillers) and a thermoset, to achieve a desired range of electrical conductivities, as mentioned above, in which the conductive filler is used to induce Joule heating, as a means to cure the thermoset. Also provided herein are porous CNF having a controlled pore shape, in which hot-drawing of a precursor was utilized to elongate the pores, which CNF can be utilized as the conductive filler of the herein disclosed hybrid material, in embodiments. In embodiments, the CNF are wavy CNF. In embodiments, the conductive filler comprises a material disparate from CNF, such as, without limitation, carbon black.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. § 1.72 and the purpose stated in 37 C.F.R. § 1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### EXAMPLES

The subject matter having been generally described, the following examples are given as particular embodiments of the disclosure and to demonstrate the practice and advantages thereof. It is understood that the examples are given by way of illustration and are not intended to limit the specification of the claims to follow in any manner.

### Example 1: CNF

### Overview/Discussion

There is a growing interest to store energy in structural components of vehicles to reduce the weight penalties associated with batteries. One such platform to accomplish that is porous load bearing fibers, such as carbon fibers and nanofibers, in which pores are induced to enhance power and energy density. However, adverse effects of pores on load bearing capacity of fibers has remained a matter of speculation. In this Example 1, the mechanics of porous carbon nanofiber (CNF) was studied for the first time via as a function of the porous structure. Hollow CNF with porous shell was prepared by coaxial electrospinning a Polyacrylonitrile (PAN)/Poly(methylmethacrylate) (PMMA) blend shell with a PMMA core. PMMA was removed by thermal decomposition during pyrolysis to form pores. Solid shell CNF was prepared as a control with no PMMA in the shell. Results show that the modulus and strength of the porous shell CNF with a porosity of 19.2±1.3% was 65.0±6.2 GPa and 1.28±0.14 GPa respectively, 13.9±2.1% and 35.5±4.9% lower than the solid shell CNF. Pore geometry analysis indicates that large portion of the mechanical properties was retained due to the elongated pore shape. Finite element analysis models were developed to decouple the contribution of stress concentration and reduced load bearing area in porous CNF on their mechanical properties.

In this Example 1, the fabrication and characterization of hollow CNF with both solid shell and porous shell fabricated using a PMMA sacrificial material in PAN is described. The pore morphology and the elastic modulus, tensile strength, and strain-to-failure, and a comparison of the strength to prediction of finite element analysis to determine the effects of pore morphology are also presented.

### Experimental

### Fabrication of Solid and Porous Shell CNF

PAN (Mw˜150 kDa), PMMA with high and low molecular weight (˜350 kDa and ˜15 kDa) and DMF were obtained from Sigma-Aldrich and used as received. PMMA (350 kDa) was dissolved in DMF at 16 wt % by stirring for 12 h and PAN was dissolved in DMF at 12 wt % using a similar method. A PAN/PMMA emulsion was made by dissolving PAN and PMMA (15 kDa) in DMF at 7.7 wt % and 15.4 wt % at the same time, the solution was stirred vigorously for 24 h before use. Polymer precursor fibers for hollow CNF were electrospun using a self-constructed coaxial electrospinning setup, the coaxial needle was comprised of a 12 gauge outer needle and a 21 gauge inner needle. To fabricate the precursor fibers for solid shell CNF, the 16 wt % PMMA (350 kDa)/DMF solution was supplied to the core needle and the 12 wt % PAN/DMF solution was supplied to the shell needle with two separate syringe pumps (Harvard Apparatus Model 11). The concentration of both solutions was selected to obtain smooth beadless fibers. To fabricate the precursor fibers for porous shell CNF, the PAN/PMMA emulsion was supplied to the shell needle and the 16 wt % PMMA/DMF solution was supplied to the core needle. The total concentration of the polymers was selected to have similar viscosity with the 12 wt % PAN/DMF solution used for the solid shell CNF. The ratio between PMMA and PAN concentration in the emulsion was selected to obtain high porosity. The shell to core flow rate ratio was kept constant at 1.4 for both cases to achieve similar shell thickness. The optimum shell and core flow rate to achieve steady Taylor cone size was found to be 0.7 mL/h and 0.5 ml/h for the solid shell CNF and 0.56 mL/h and 0.4 ml/h for the porous shell CNF. The electrospinning voltage and distance were set at 15 kV and 20 cm. Fibers were collected on a grounded rotary drum at a takeup velocity of 3.9 m/s, corresponding to an angular velocity of 500 rpm. The temperature and relative humidity during electrospinning were controlled at 25±1° C. and 40±2% respectively. After electrospinning, the precursor fibers were peeled off the drum collector and stabilized in a convection oven at 270° C. for 2 h in an air atmosphere. The stabilized fibers were then thermally treated in nitrogen atmosphere at 1100° C. for 1 h in a tube furnace (MTI GSL-1700X) with a ramp rate of 5° C./min.

### Material Characterization

The morphology of CNF was analyzed by field-emission scanning electron microscope (FEI Quanta 600 FE-SEM). To image the cross section of the fibers, they were cut with a razor blade and mounted with the cross sections normal to the electron beam. The fiber diameter and shell thickness were measured from SEM images with ImageJ software. Raman spectra of CNF were obtained by Horiba Jobin-Yvon LabRam Raman confocal microscope with a He—Ne laser (633 nm).

The pore structure of the fibers was studied by collecting N2 adsorption isotherms at 77K with Quantachrome Autosorb iQ. Before the adsorption test, samples were degassed for 4 h at 250° C. under vacuum. The specific surface area was calculated by Brunauer-Emmett-Teller (BET) theory. The pore size distribution was obtained by quenched solid density functional theory (QSDFT) assuming cylindrical pores. The total pore volume was obtained from total amount of N2 adsorption at relative pressure close to 1.

The mechanical properties of the CNF were obtained by single fiber tensile tests using an in-house designed MEMS device (fabricated by MEMSCAP Inc). Single carbon fibers was placed on the MEMS device using a tungsten probe controlled by a micro-manipulator under an optical microscope. A Platinum block was deposited using Focused Ion Beam (FIB) (Tescan LYRA-3 Model GMH Focused Ion Beam Microscope) to grip the fiber. During the tensile test, the MEMS was actuated by a picomotor actuator (Newport Picomotor Actuator 8303) with a speed of 2 step/s and step size of 30 nm. Optical images were captured using an optical microscope during the test. The force and displacement were determined by analyzing the images using digital image correlation (DIC) software (VIC-2D). After the test, the fiber fracture surface was observed by SEM and the cross-sectional area of the shell was measured on SEM images to determine the stress. Focused ion beam (FIB) etching was used to cut along the fibers to examine the longitudinal cross-section.

### Results and Discussion

Morphology of CNF with Solid and Porous Shell

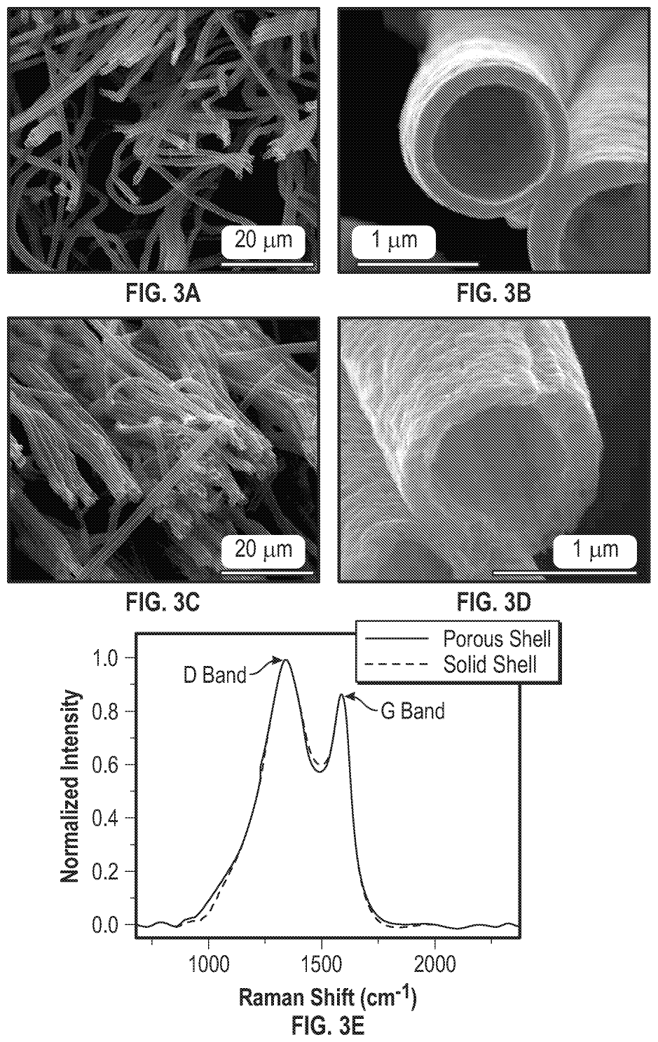

As explained in the Experimental section, PMMA in DMF solution was used to form the core of the precursor fibers, while PAN/PMMA emulsion and PAN solution in DMF was used to form precursor shells of porous and solid shell CNF, respectively. In the PAN/PMMA emulsion used for the porous shell, PAN/DMF phase has lower surface tension than the PMMA/DMF phase, as a result, PAN/DMF formed the continuous phase and PMMA/DMF formed the dispersed phase. During the thermal treatment at 1100° C., PAN molecules undergo cyclization and form the carbon structure, PMMA in the both the shell and the core decomposes into gaseous phase to form the hollow core and pores. FIG. 3A and FIG. 3B depict SEM images of the hollow carbon nanofibers (HCNF) with solid shell and FIG. 3C and FIG. 3D show SEM images of the HCNF with porous shell. As expected, a hollow core was formed in both cases with uniform shell thickness. However, on solid shell CNF, the cross-section is continuous with no observable void (FIG. 3B), whereas in porous shell CNF, a highly porous structure was observed with a large number of pores spread across the cross-section (FIG. 3D).

The average outer diameter of CNF with solid and porous shell was measured to be 1.50±0.23 μm and 1.61±0.29 μm respectively. The average shell thickness for CNF with solid shell and porous shell was nearly identical, values of 0.23±0.06 μm and 0.24±0.06 μm respectively.

FIG. 3E shows Raman spectra of porous and solid shell CNF of this Example 1. Despite differences in the morphology of the shell, the Raman spectra for porous shell and solid shell CNF, shown in FIG. 3E, suggest that both types of fibers have similar partially graphitic structures. The two peaks appeared at about 1336 cm⁻¹ and about 1580 cm⁻¹ corresponds to defects (D peak) and graphitic structures (G peak) of carbon materials. The intensity ratio of the D peak to G peak indicates the defect density and quality of graphitic domain, and it is related to the graphitic domain size and defect density within the graphitic domains. The ID/IG ratio for the porous shell and solid shell is very close, 1.21 and 1.16 respectively. The similar ID/IG ratio suggests that the existence of PMMA in the shell did not affect the molecular structure of carbonized PAN.

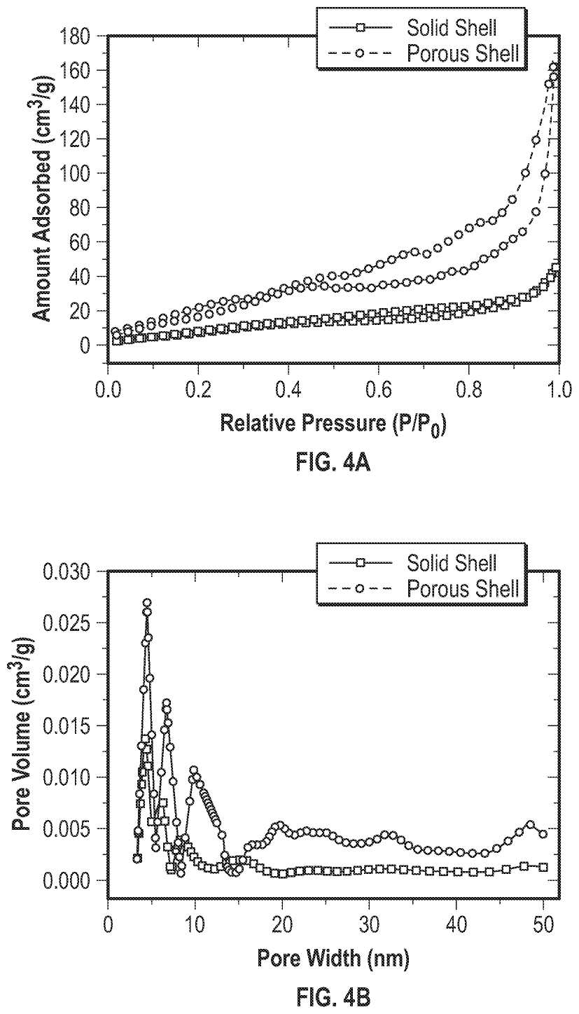

The porous structure was studied by N² adsorption. FIG. 4A shows the N² adsorption isotherms of CNF with solid and porous shells. Adsorption at low relative pressure 0˜0.2 is attributed to micropores (pore width smaller than 3 nm). In both types of fibers, the low adsorption amount indicated that there is only a small amount of micropores. These micropores are likely surface pores and roughness on the inner and outer surfaces of the shell. Adsorption at higher relative pressure 0.8˜1 is related to mesopores (pores width between 3 nm to 50 nm). The mesopore size distribution of solid and porous shell CNF were calculated using the QSFDT method. FIG. 4B is a pore size distribution plot for the solid and porous shell HCNF of this Example 1. In the case of solid shell CNF, there is small amount of mesopores, as can be seen from the low adsorption amount as well as on the pore size distribution plot in FIG. 4B. In contrast, the porous shell CNF have significantly more mesopores, which can be seen from the high adsorption and the pore size distribution. This observation is consistent with SEM images (FIG. 3D). The specific surface area (SSA) of the CNF with solid shell and porous shell was respectively 36.1 m²/g and 87.2 m²/g, and the total pore volume is 0.070 cm³/g and 0.243 cm³/g respectively, as shown in Table 1.

The increase in SSA and pore volume is a result of the mesoporous structure created by decomposition and departure of PMMA during the thermal treatment which leave pores behind.

TABLE 1
Porous Structure Properties of Hollow CNF of Example 1

| | BET Specific | Total Pore | | Normalized |
|---|---|---|---|---|
| | Surface Area | Volume | Porosity | Porosity |
| | (m²/g) | (cm³/g) | (P) | (Pₙ) |
| Solid Shell | 36.1 | 0.070 | 11.2% | — |
| Porous Shell | 87.2 | 0.243 | 30.4% | 19.2% |

Mechanical Properties of CNF with Solid and Porous Shells

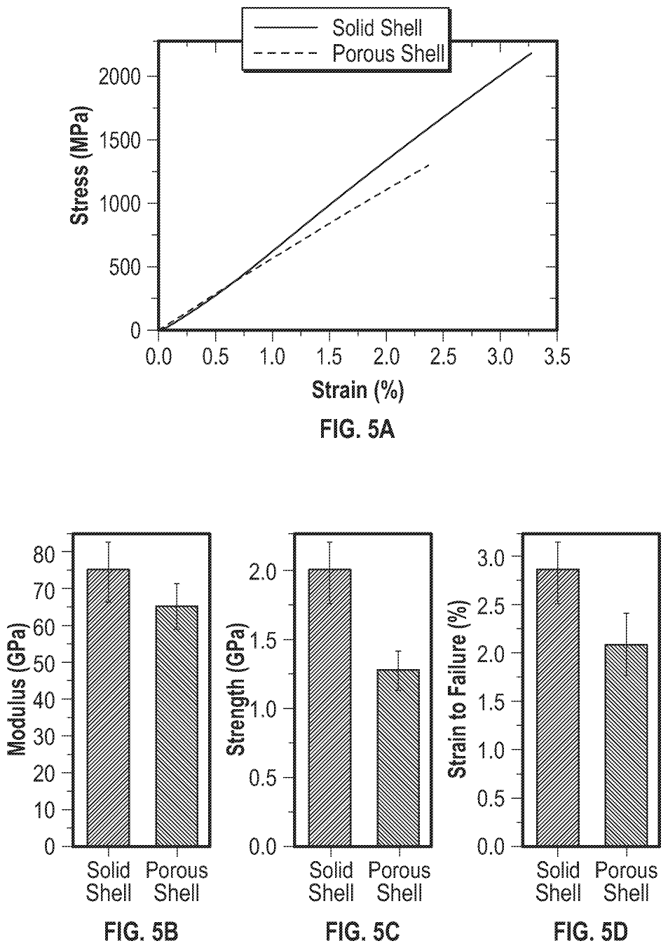

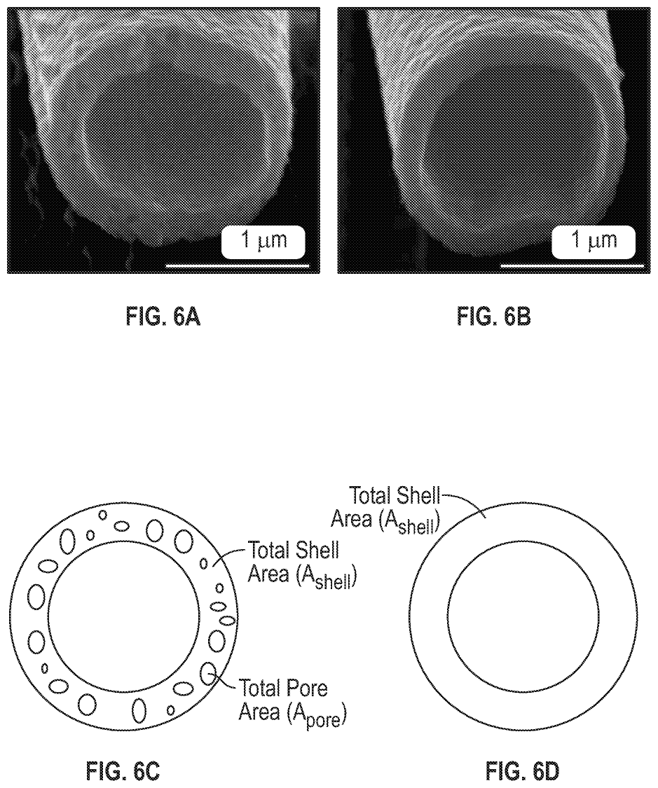

FIG. 5A is a plot of representative stress-strain curves of solid and porous shell CNF tensile tests. In both cases, the CNF remained elastic until fracture and experienced brittle fracture. The mechanical properties are summarized in Table 2 and FIG. 5B, which is a bar graph of the average modulus of the solid shell and porous shell HCNF, FIG. 5C, which is a bar graph of the strength of the solid shell and porous shell HCNF, and FIG. 5D, which is a bar graph of the strain to failure of the solid shell and porous shell HCNF. FIG. 6A shows SEM images of the fracture (failure) surface of the porous shell HCNF; FIG. 6B shows SEM images of the fracture (failure) surface of the solid shell HCNF.

FIG. 6C is a schematic depiction of the cross section of the porous shell HCNF of Example 1; FIG. 6D is a schematic depiction of the cross section of the porous shell HCNF of Example 1. The total cross-sectional shell area (Aₛₕₑₗₗ), which is the geometric area of the shell, including the area of the pores in each cross section, was measured in both cases to calculate the apparent modulus and strength. Five fibers were tested for each case. The average apparent modulus, apparent strength and strain to failure for the solid shell CNF was 75.6±9.2 GPa, 1.99±0.18 GPa and 2.8±0.2%. The average apparent modulus, apparent strength and strain to failure for the porous shell CNF was 65.0±6.2 GPa, 1.28±0.14 GPa and 2.1±0.3%. Surprisingly, the mechanical properties of the porous shell CNF were not significantly lower than for the solid shell CNF: the apparent modulus, apparent strength and the strain to failure of the porous shell CNF reduced by 13.9±2.1%, 35.5±4.9% and 25.8%±4.5%.

TABLE 2
Mechanical Properties of Hollow CNF of Example 1

| | Apparent | True | Apparent | True | Strain to |
|---|---|---|---|---|---|
| | Modulus (GPa) | Modulus (GPa) | Strength (GPa) | Strength (GPa) | Failure (%) |
| Solid Shell CNF | 75.6 ± 9.2 | — | 1.99 ± 0.18 | — | 2.8 ± 0.2 |
| Porous Shell CNF | 65.0 ± 6.2 | 80.5 ± 7.2 | 1.28 ± 0.14 | 1.59 ± 0.17 | 2.1 ± 0.3 |
| Reduction (%) | 13.9 ± 2.1 | −6.5 ± 1.0 | 35.5 ± 4.9 | 20.1 ± 2.8 | 25.8 ± 4.5 |

### Strength Compromising Parameters and Design of Resilient Porous Nanofibers

As discussed hereinabove, the similar ID/IG ratio in Raman spectra indicates similar graphitic domain quality for two cases. Thus, the loss of strength and modulus should be attributed to the differences in stress distribution between porous and solid shell CNF. The pores can cause stress concentrations and also reduce the effective load bearing area which leads to lower mechanical properties. The former will lead to local and propagating failure by generating non-uniform stress fields, while the strength loss in the latter is proportional to the porosity of the fibers.

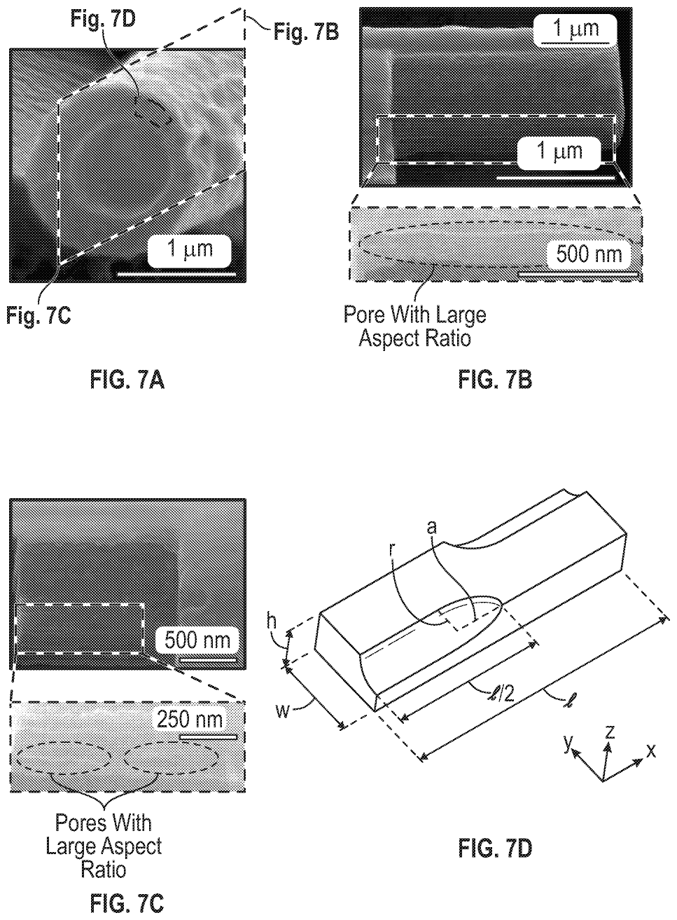

The stress concentration effect is strongly dependent on the pore shape. An elongated cylindrical pore, with its longest diameter along the axis of the fiber, causes a significantly lower stress concentration and consequent loss in strength compared to a spherical pore. Therefore, the pore shape was examined by SEM to relate the strength loss in porous CNF to the pore geometry. To this end and to expose the internal pores, a longitudinal cut was made in porous shell CNF by FIB. FIG. 7A is a SEM image of the fracture surface of the porous shell CNF after mechanical test; FIGS. 7B and 7C depict longitudinal cross sections of porous shell CNF obtained through FIB etching, and FIG. 7D is a schematic for the Representative Volume Element (RVE) used in the finite element analysis. As shown in FIG. 7B and FIG. 7C, the pores have high aspect ratio and are elongated along the fiber direction. This pore shape is consistent with findings in literature and is due to the stretching of the emulsion and the colloids of PMMA during electrospinning. This may explain why the mechanical properties of porous shell CNT did not reduce significantly comparing the solid shell CNF.

Moreover, the reduction in load bearing portions of the cross section area (porosity) can also lower the strength. The porosity can be calculated using the total specific pore volume (i.e., pore volume per unit mass) from adsorption and the density of PAN based carbon fiber (ρ=1.7˜1.9 g/cm³) with the following equation: P=Vp/(Vp+1/ρ). The porosity of CNF with solid shell and porous shell is 11.2±0.6% and 30.4±1.2% respectively. As shown previously, the CNF with solid shell has no observable pores inside the shell, therefore the porosity is due to pores on the surface.

To relate the mechanical properties to porosity in porous shell CNF, the porosity in porous shell CNF must be adjusted with respect to the porosity of solid shell CNF. This adjustment assumes that the CNF with solid shell and porous shell have similar surface pore volume thus similar contribution to the mechanical properties. Thus, a normalized porosity (Pn) for the porous shell CNF can be calculated as the porosity difference between the porous and solid shell CNF.

The normalized porosity (Pₙ) of the porous shell CNF is 19.2±1.3%. When examining the mechanical property reduction, the apparent modulus reduction of 13.9±2.1% is similar to the normalized porosity within uncertainty, whereas the reduction in apparent strength and strain to failure of 35.5±4.9% and 25.8%±4.5% are much higher than the normalized porosity. This analysis suggests that the apparent modulus is linked to the area reduction. If the pores are fully aligned along fiber direction and have very high aspect ratio, the apparent modulus can be predicted by the rule of mixtures, and the reduction in modulus will be equal to the reduction in area. On the other hand, the reduction in apparent strength outweighs the reduction in load bearing area of CNF, and therefore requires the consideration of stress concentrations.

To separate the effect of area loss and stress concentration, the true modulus and true strength for the porous shell CNF can be calculated by excluding the pore area in the cross-sectional area when calculating stress. Assuming the adjusted porosity (Pₙ) is only a result of the mesoporous structure, the area porosity is equal to the normalized porosity. Thus, the true modulus can be calculated as: Eₜᵣᵤₑ=E/(1−Pₙ), and a similar calculation was done for strength. Similarly, the true modulus and true strength are 80.5±7.2 GPa and 1.59±0.17 GPa. Compared to solid shell CNF, the true modulus increased by 6.5±1.0% and the true strength reduced by 20.1±2.8%. The true modulus was not expected to change; the slight increase in true modulus is speculated to reflect the cumulative uncertainty in the adsorption measurement and mechanical test. The reduction in true strength due to stress concentration is discussed in more detail in the following section.

### Prediction of Strength Reduction in Porous Shell CNF Via Continuum Mechanics Models

To shed light on the measured loss of strength when pores are present in terms of stress concentrations, the mechanical behavior of CNF was studied using continuum mechanics models implemented using finite element analysis (FEA). The material properties used in the model was obtained from PAN based carbon fiber. To this end, a representative volume element (RVE) of the porous fiber was constructed, as depicted in FIG. 7D. The pores were modeled as cylinders with semi-ellipsoidal caps (ellipsoid of revolution). The pore shape was defined by three parameters: length (l), radius (r) and length of ellipsoidal cap (a). The RVE contains two identical pores with each one being one-eighth of a complete pore. The inclusion of two pores with finite length was guided by experimental observation of discontinuous pores. Moreover, the consideration of two pores allows us to take into account the effects each pore can have on the stress fields of the other. Based on SEM images of porous shell CNF, the pore cap geometry parameter, a/r, was chosen to be about 1 to 5, and the aspect ratio of the pores (l/r) was chosen to be about 5 to 40. In this RVE, the porosity is defined as P=(πr²)/(4hw), which is the area porosity, which is equal to the adjusted volumetric porosity stated earlier in section 3.3.

In the FEA model, symmetric boundary conditions were applied to planes at x=0, y=w, z=h. A planar constraint was applied to y=0, FIG. 7D. A displacement boundary condition was applied at x=l, where the displacement u=l*1% (equivalent to an average strain of 1%). As a result of the applied displacement, the force resultant F_{d} was calculated from the model. It is to be noted that due to the existence of the pore, F_{d} is a result of a non-uniform stress field. In this model, the apparent average stress is equal to the resultant force divided by the total cross section area (hw), or σ apparent=F_{d}/(hw), and the true average stress is equal to the ratio of the resultant force over the net cross section area of the fiber excluding the area of the pores (hw−πr²/4), or σₜᵣᵤₑ=F_{d}/(hw−πr²/4). Thus, the apparent and true stress concentration factor is defined as Kₐₚₚₐᵣₑₙₜ=σₘₐₓ/σₐₚₚₐᵣₑₙₜ and Kₜᵣᵤₑ=σₘₐₓ/σₜᵣᵤₑ, where σₘₐₓ is the maximum principle stress.

A failure criterion is required to predict the loss in strength due to the pores. Since the CNF experienced brittle fracture, the maximum principle stress was chosen as the failure criteria. Hence, the strength reduction of the porous shell CNF can be calculated as (1−1/K)*100%. When Kₐₚₚₐᵣₑₙₜ is used, the strength reduction is due to the combination of both area loss and stress concentration, showed as black line in the results, whereas when Kₜᵣᵤₑ is used, the strength reduction is only a result of stress concentration effect, showed as blue line in the results.

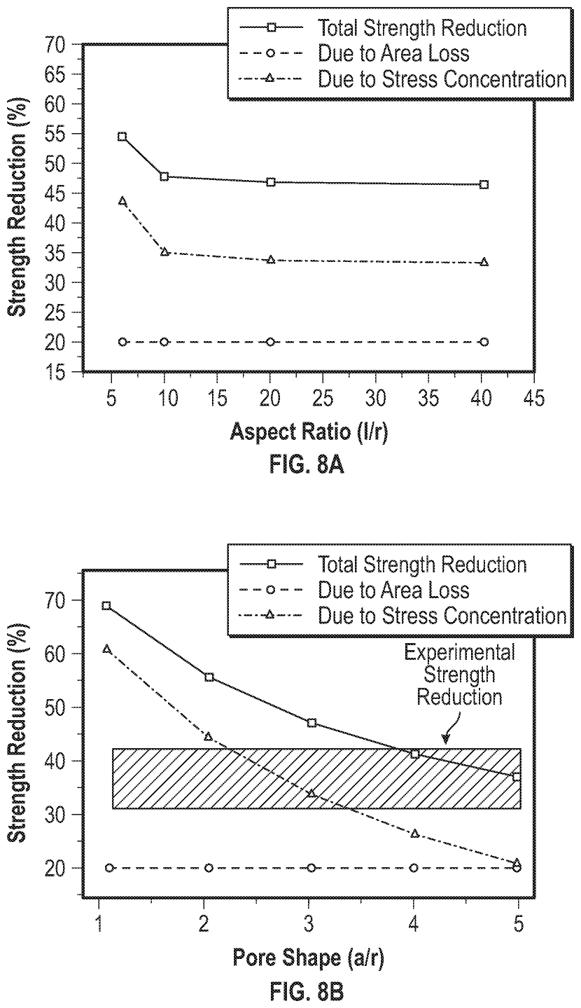

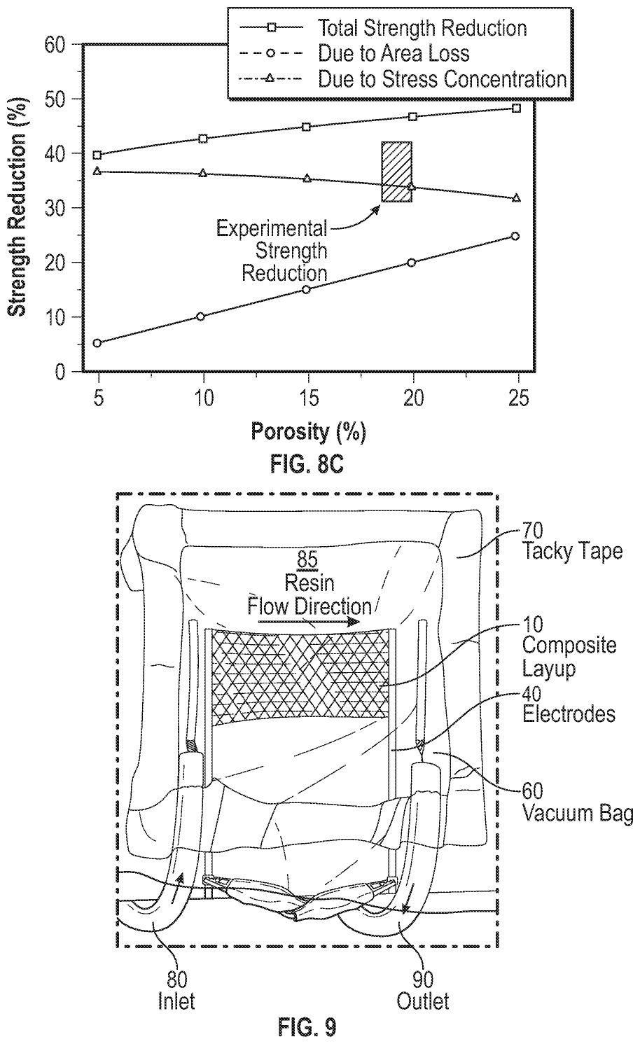

FIG. 8A, FIG. 8B, and FIG. 8C are plots of the strength reduction as a function of the pore aspect ratio (l/r), the pore shape (a/r), and the porosity (%), respectively. The pore geometry in the porous CNF is more complex than the model. Hence, the accuracy of the model is considered. In the model, with a porosity of 20%, a/r=3 and l/r=20, Kₐₚₚₐᵣₑₙₜ is 1.89 and the strength reduction is 47.1% if maximum principle stress is used as the failure criteria. This result is relatively close to the 35.5±4.9% strength reduction with a porosity of 19.2±1.3% in the experimental results (cross-hatched box in FIG. 8B and FIG. 8C). Therefore, the model is fairly accurate and can provide a good qualitative prediction for the strength of the porous CNF.

Some simple parametric studies were conducted to study the influence of pore geometry on the strength of the porous CNF. The influence of aspect ratio on the strength was first studied by changing l, with r=50 nm, a=/50 nm and P=20%. The result is shown in FIG. 8A. As shown in FIG. 8A, the aspect ratio only affect the strength when the aspect ratio is smaller than 10 and it has very small influence on the strength. In the following study, an aspect ratio of 20 was used for all cases.

In order to study the influence of pore shape (a/r), r was kept constant at r=50 nm and a was changed to from 50 nm to 250 nm, P=20% was used. The results are shown in FIG. 8B. The results in FIG. 8B indicate that there is a large dependence of strength on the pore shape (a/r). With longer pores, the stress concentration reduces significantly which leads to lower strength reduction. Furthermore, the influence of porosity on strength was also studied, r=50 nm and a=150 nm was used in this case, w was changed from 75 nm to 400 nm to have a porosity of 5% to 25%. The results are shown in FIG. 8C. The results in FIG. 8C indicate that the porosity has very small influence on the stress concentration effect (blue line), but the area reduction increases linearly with porosity. As a result, the total strength reduction increases with porosity.

### Conclusion

In this Example 1, hollow carbon nanofibers (CNF) with both porous and solid shells were fabricated by coaxial electrospinning and emulsion electrospinning using PAN as carbon precursor and PMMA as sacrificial component. The microstructural characterization showed a well-developed porous structure in the porous CNF. The BET specific area of 87.2 m²/g was achieved on the porous shell CNF. The mechanical properties of the hollow CNF with porous and solid shell were characterized by single fiber MEMS test. The modulus, strength, and strain to failure of the solid shell CNF and porous shell CNF was 75.6±9.2 GPa and 65.0±6.2 GPa, 1.99±0.18 GPa and 1.28±0.14 GPa and 2.8±0.2% and 2.1±0.3%, respectively. The modulus, strength, and the strain to failure decreased by 13.9±2.1%, 35.5±4.9% and 25.8%±4.5%, respectively, due to the porous structure. The mechanical properties were reduced by stress concentrations and area reduction. Continuum mechanics models of the porous shell CNF were built to study the influence of the pore geometry on the strength of porous CNF. The model predicted a 40%˜70% strength reduction at 20% porosity. Porosity and pore aspect ratio have limited influence on strength. Pore shape was identified to have the most significant influence on the strength.

### Example 2: Composite Composition

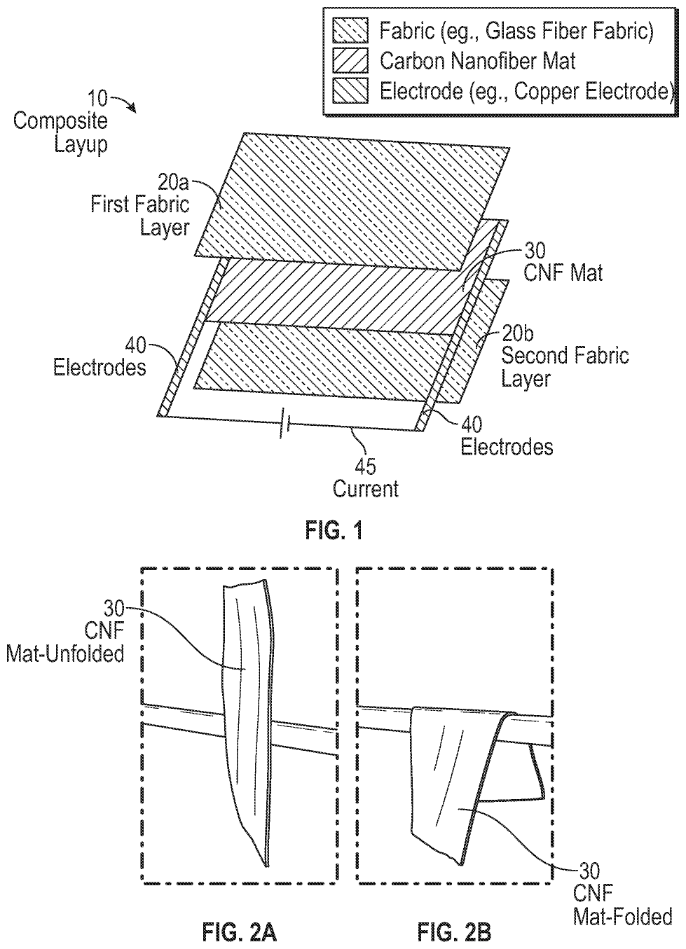

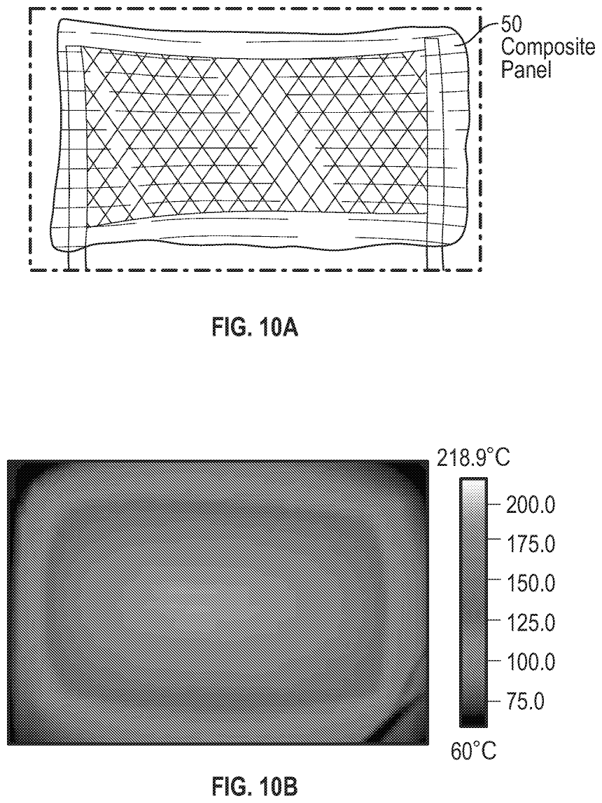

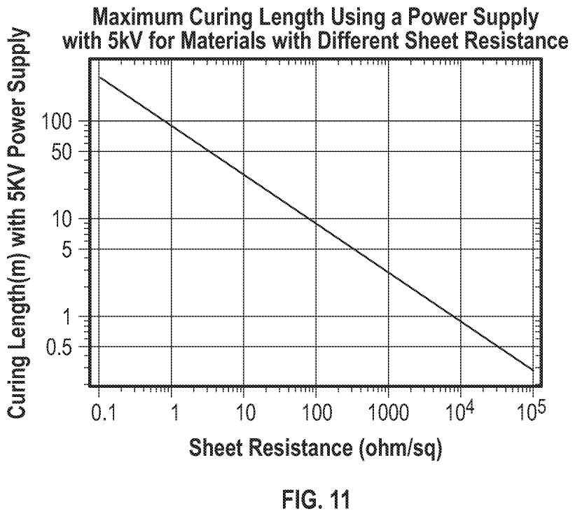

As depicted in FIG. 1, which is a schematic of a composite layup 10 according to embodiments of this disclosure, a composite layup 10 was formed comprising a CNF mat 30 sandwiched between two layers of glass fiber fabric, a first fabric layer 20a and a second fabric layer 20b. Copper electrodes 40 were attached to the CNF mat 30 using conductive silver paint. The fabric was dry and comprised the resin Epon 862/Epikure W. The CNF mat 30 was formed by carbonization of electrospun PAN nanofibers. As depicted in FIG. 2A, which shows the CNF mat 30 in an unbent configuration and FIG. 2B, which shows the CNF mat 30 in a folded configuration, the CNF mat 30 exhibited good flexibility. A glass fiber composite (also referred to as a “composite panel” or “panel”) 50 was fabricated by vacuum assisted resin transfer molding (VARTM), as depicted in FIG. 9, which is a schematic of the VARTM setup. Specifically, the layup of the composite is shown in FIG. 1, a CNF mat is sandwiched between two dry glass fiber fabrics, the layup was enclosed in a vacuum bag 60 and sealed with tacky tape 70, the inlet was closed and vacuum pump was connected to the outlet 90. When vacuum was reached, the inlet 80 was opened and the resin was injected through the inlet 80. Resin flow direction is indicated at arrow 85 in FIG. 9. Once the entire layup was wet by the resin, the panel was cured with joule heating using the CNF mat 30 as the heating element by running current through the CNF mat 30. A current of 1.07 A was applied with a voltage of 23.1 V. FIG. 10A is a schematic of the cured composite 50 (also referred to as a “composite panel 50”). The average temperature at equilibrium was 177° C. A relatively uniform temperature distribution was observed, as shown in FIG. 10B, which is a schematic of the temperature distribution throughout the panel during the curing process.

The composition of the cured panel 50 is shown in Table 3.

TABLE 3
Composition of Cured Panel of Example 2

| | Weight | wt % |
|---|---|---|
| Glass Fibers (g) | 10.10 | 68.3% |
| CNF (mg) | 18.90 | 0.13% |
| Resin (g) | 4.66 | 31.5% |
| Final Composite (g) | 14.78 | |

### Example 3: CNF Mat

In this Example 3, the maximum curing length using a power supply with 5 kV for materials having different sheet resistance (Rₛ) was determined. The materials included a CNF mat of this disclosure comprising CNF formed as described in Example 2 hereinabove, a conductive plastic film, and an aluminum sheet. Specifically, the CNF mat was formed by carbonization of electrospun PAN nanofibers (in the absence of PMMA in the precursor and without hot-drawing). When the conductive plastic film was considered, the required voltage exceeds common safety operation range for high power supply (5 kV). In the case of the aluminum sheet, the required current exceeded normal operation condition for a power generator.

Table 4 provides the data for this Example 3. The sheet resistance Rₛ was calculated as Rₛₕₑₑₜ=(V²)/(L²*P_{d}), where P_{d} is the power density, L is the length, and V is the voltage, and the current I=(πD)/(√(Rₛ/P_{d}), where D is the diameter.

TABLE 4
Data for Example 3

| | | | | P_{d} to Cure | Pipe | Pipe | Required | Required |
|---|---|---|---|---|---|---|---|---|
| | Resistivity | Thickness | Rₛ | at 130° C. | Diameter, | Length, | Voltage | Current |
| Material | (ohm*m) | (m) | (ohm/sq) | (W/m²) | D (m) | L (m) | (V) | (A) |
| CNF Mat | 5.00E−05 | 0.01 | 5 | 3000 | 0.5 | 10 | 1224.7 | 38.5 |
| Conductive | 1.00E+01 | 0.1 | 1.00E+05 | 3000 | 0.5 | 10 | 173205.1 | 0.3 |
| Plastic Film | | | | | | | | |
| Aluminum | 2.60E−08 | 0.01 | 0.0026 | 3000 | 0.5 | 10 | 27.9 | 1687.3 |
| Sheet | | | | | | | | |

FIG. 11 is a plot of the curing length (m) with 5 kV power supply as a function of the sheet resistance Rₛ.

### Example 4: CIPP

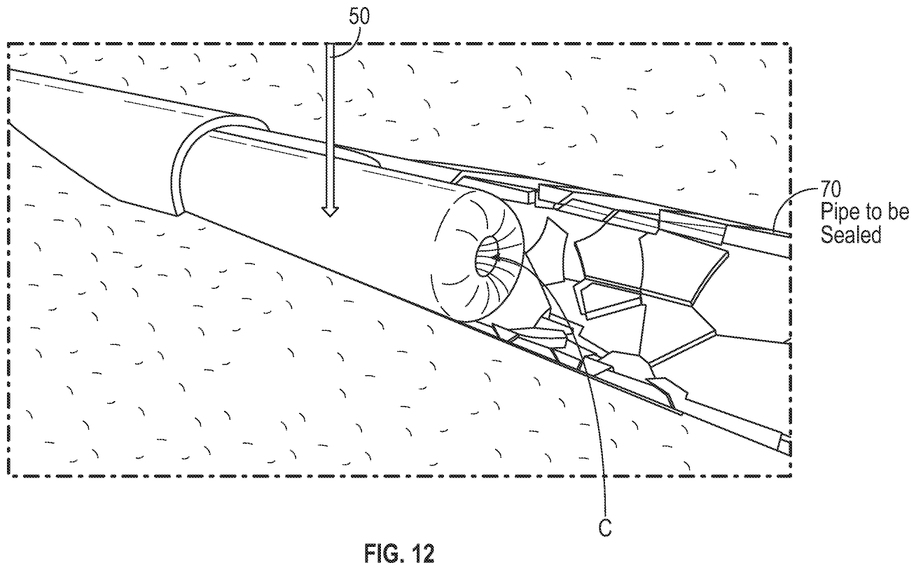

A hybrid material or composite of this disclosure can be utilized for CIPP. FIG. 12 is a schematic of a CIPP process, according to embodiments of this disclosure. A hybrid material 50 according to this disclosure comprising a CIPP fabric liner of this disclosure comprising a thermosetting resin and having impregnated therein a conductive filler (e.g., CNF) is placed within a pipe to be sealed 70 and electricity supplied to the CIPP liner to cure the CIPP liner in place. In embodiments, air or another fluid may be inserted into a center of the CIPP liner to expand it within the broken pipe to be sealed 70, prior to curing the CIPP liner in place within pipe 70, whereafter the fabric liner seals the broken pipe 70, providing a cured in place pipe (CIPP).

While various embodiments have been shown and described, modifications thereof can be made by one skilled in the art without departing from the spirit and teachings of the disclosure. The embodiments described herein are exemplary only, and are not intended to be limiting. Many variations and modifications of the subject matter disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L} and an upper limit, R_{U} is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural, or other details supplementary to those set forth herein.

### ADDITIONAL DESCRIPTION

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Alternative embodiments that result from combining, integrating, and/or omitting features of the embodiment(s) are also within the scope of the disclosure. While compositions and methods are described in broader terms of “having”, “comprising,” “containing,” or “including” various components or steps, the compositions and methods can also “consist essentially of” or “consist of” the various components and steps. Use of the term “optionally” with respect to any element of a claim means that the element is required, or alternatively, the element is not required, both alternatives being within the scope of the claim.

Numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Embodiments disclosed herein include:

Embodiment A: A curing process comprising: providing a hybrid material comprising a conductive filler in contact with a thermosetting resin; and passing an electric current through the hybrid material to provide Joule heating until a temperature of the hybrid material reaches a temperature above a curing temperature of the thermosetting resin.

Embodiment B: A process comprising: forming a plurality of precursor fibers, wherein the plurality of precursor fibers comprise a polymer, drawing the plurality of precursor fibers at a drawing temperature above room temperature; and subjecting the plurality of precursor fibers to a pyrolysis process after the drawing.

Embodiment C: A hybrid material comprising a conductive filler in contact with a thermosetting resin or a thermoplastic resin, wherein the thermosetting resin or the thermoplastic resin is in contact with a flexible fabric, and wherein the hybrid material comprises from about 0.1 to about 10 weight percent (wt %) of the conductive filler, wherein the hybrid material has a conductivity such that an electric current in a range of from about 0.1 to about 10 Amperes (A) can be passed through the hybrid material to provide Joule heating such that a temperature of the hybrid material reaches a temperature above a curing temperature of the thermosetting resin or a melting temperature of the thermoplastic resin whereby the thermosetting resin can be cured or the thermoplastic resin can be melted.

Embodiment D: Forming a cured in place pipe (CIPP) or a habitat from the hybrid material of Embodiment C.

Embodiment E: Thermoforming a hybrid material of Embodiment C comprising the thermoplastic resin by Joule heating, whereby the thermoplastic resin is heated to a temperature above a melting point thereof, the hybrid material assumes a new shape, and, upon cooling of the thermoplastic resin below the melting point thereof, solidifies.

Embodiment F: A composite material comprising a thermoplastic material and a conductive filler selected from carbon fibers, carbon nanofibers (CNF), graphene particles, graphene nanoparticles, carbon black, metallic particles, metallic fibers, metallic meshes, or a combination thereof, whereby the thermoplastic material can be heated to a temperature above a melting temperature and/or a softening point thereof via Joule heating.

Each of embodiments A, B, C, D, E, and F may have one or more of the following additional elements: Element 1: wherein the conductive filler is selected from carbon fibers, carbon nanofibers (CNF), graphene particles, graphene nanoparticles, carbon black, metallic particles, metallic fibers, metallic meshes, or a combination thereof. Element 2: wherein the conductive filler comprises CNF. Element 3: wherein the CNF were produced via a method comprising hot drawing of precursor fibers. Element 4: further comprising forming the CNF. Element 5: wherein forming the CNF further comprises: forming a plurality of precursor fibers, wherein the plurality of precursor fibers comprise a polymer, drawing the plurality of precursor fibers at a drawing temperature, wherein the drawing temperature is above room temperature; and subjecting the plurality of precursor fibers to a pyrolysis process after the drawing, whereby the polymer carbonizes to provide the CNF. Element 6: wherein the polymer comprises polyacrylonitrile (PAN), polyvinylidene fluoride (PVDF), pitch and lignin, or a combination thereof. Element 7: wherein the pyrolysis process includes a pyrolysis temperature of greater than or equal to about 1400° C. Element 8: wherein the drawing temperature is lower than the pyrolysis temperature and greater than or equal to the glass transition temperature (T_{g}) of the precursor fibers. Element 9: wherein forming the plurality of precursor fibers comprises electrospinning. Element 10: wherein the precursor fibers comprise the polymer and another polymer, and wherein the another polymer decomposes during the pyrolysis process to form pores in the CNF. Element 11: wherein the another polymer comprises polymethylmethacrylate (PMMA), polystyrene (PS), silicon dioxide (SiO₂) or a combination thereof. Element 12: wherein the conductive filler comprises a network of the CNF. Element 13: wherein providing the hybrid material comprising the conductive filler in contact with the thermosetting resin comprises embedding the network of CNF in the thermosetting resin. Element 14: wherein the network of the CNF comprises a CNF mat. Element 15: wherein providing the hybrid material comprising the conductive filler in contact with the thermosetting resin comprises sandwiching the CNF mat between a first fabric layer and a second fabric layer, wherein a side of the first fabric layer proximate the CNF mat, a side of the second fabric layer proximate the CNF mat, or both comprise the thermosetting resin distributed therein. Element 16: wherein the thermosetting resin is within a cured in place pipe (CIPP) liner. Element 17: wherein the CIPP liner comprises a fabric liner impregnated with the thermosetting resin. Element 18: wherein the hybrid material comprises less than about 10 wt % of the conductive filler. Element 19: wherein the hybrid material comprise greater than or equal to 0.1 wt % of the conductive filler. Element 20: wherein the curing temperature is in the range of from about 70° C. to about 160° C. Element 21: wherein the hybrid material has an sheet resistance in the range of from about 1*10⁻⁵ to about 20*10⁻⁵ ohm-meter (Ω·m). Element 22: wherein passing an electric current through the hybrid material comprises providing an electrical current of less than or equal to about 1, 5, or 10 Amperes (A). Element 23: wherein a voltage applied to the hybrid material during the curing process is in a range of from about 10 to about 200 volts (V) per meter length of the hybrid material. Element 24: further comprising: forming a plurality of carbon nanofibers (CNF) during the subjecting of the plurality of precursor fibers to the pyrolysis process after the drawing; forming a network of the CNF; contacting the network of the CNF with a thermosetting or thermoplastic resin to form a hybrid material; and passing an electric current through the hybrid material. Element 25: comprising contacting the network of the CNF with a thermosetting resin to form the hybrid material. Element 26: wherein passing the electric current through the hybrid material is effected such that Joule heating heats the hybrid material to a temperature of greater than or equal to the curing temperature of the thermosetting resin and optionally maintaining the elevated temperature until the thermosetting polymer is thermoset. Element 27: wherein the curing temperature is in the range of from about 70° C. to about 160° C. Element 28: wherein the hybrid material has a sheet resistance in the range of from about 1*10⁻⁵ to about 20*10⁻⁵ ohm-meter (Ω·m). Element 29: wherein passing the electric current through the hybrid material comprises providing an electric current of less than or equal to about 1, 5, or 10 Amperes (A). Element 30: wherein a voltage applied to the hybrid material during the curing process is in a range of from about 10 to about 200 volts (V) per meter length of the hybrid material. Element 31: wherein the thermosetting resin is distributed within a flexible fabric. Element 32: further comprising forming the flexible fabric having the thermosetting resin distributed therein by vacuum assisted resin transfer molding (VARTM). Element 33: wherein the thermosetting resin is distributed within a cured in place pipe (CIPP) liner. Element 34: wherein the CIPP liner comprises a fabric liner impregnated with the thermosetting resin. Element 35: wherein the thermosetting resin comprises an epoxy resin, a vinyl ester resin, an unsaturated polyester resin or a combination thereof. Element 36: wherein contacting the network of the CNF with the thermosetting or thermoplastic resin to form the hybrid material comprises embedding the network of the CNF in the thermosetting or thermoplastic resin. Element 37: wherein the network of the CNF comprises a CNF mat. Element 38: wherein contacting the network of the CNF with the thermosetting or thermoplastic resin to form the hybrid material comprises sandwiching the CNF mat between a first fabric layer and a second fabric layer, wherein a side of the first layer proximate the CNF mat, a side of the second layer proximate the CNF mat, or both comprise the thermosetting resin or the thermoplastic resin. Element 39: wherein the hybrid material comprises less than or equal to about 10 weight percent (wt %) of the CNF. Element 40: wherein the hybrid material comprises greater than or equal to about 0.1 weight percent (wt %) of the CNF. Element 41: wherein the conductive filler comprises carbon nanofibers (CNF). Element 42: wherein the network of the CNF is embedded in the thermosetting resin or the thermoplastic resin. Element 43: wherein the network of CNF comprises a CNF mat. Element 44: wherein the CNF mat is sandwiched between a first layer of the flexible fabric and a second layer of the flexible fabric, and wherein the first layer of fabric, the second layer of the fabric, or both comprises the thermosetting resin or the thermoplastic resin. Element 45: wherein the CNF have an aspect ratio of greater than or equal to about 1000, 5,000, or 10000, and/or a diameter of less than or equal to about 500, 400, 300, 200, or 100 nm, as a result of production thereof via: forming a plurality of precursor fibers via electrospinning, wherein the plurality of precursor fibers comprise a polymer, drawing the plurality of precursor fibers at a drawing temperature, wherein the drawing temperature is greater than or equal to the glass transition (T_{g}) temperature of the precursor fibers; and subjecting the plurality of precursor fibers to a pyrolysis process at a pyrolysis temperature after the drawing, whereby the polymer carbonizes to provide the CNF, wherein the pyrolysis temperature is greater than the T_{g} temperature. Element 46: wherein the hybrid material comprises a cured in place pipe (CIPP) liner comprising a liner of the flexible fabric impregnated with the thermosetting resin and further comprising the conductive filler. Element 47: wherein the flexible fabric can be stretched by at least 5, 10, or 15% from an initial length thereof. Element 48: wherein the flexible fabric has a melting temperature greater than the curing temperature of the thermosetting resin and/or the melting temperature of the thermoplastic resin. Element 49: wherein the flexible fabric comprises fiberglass, natural fibers, synthetic fibers, or a combination thereof.

While preferred embodiments of the invention have been shown and described, modifications thereof can be made by one skilled in the art without departing from the teachings of this disclosure. The embodiments described herein are exemplary only, and are not intended to be limiting. Many variations and modifications of the invention disclosed herein are possible and are within the scope of the invention.

Numerous other modifications, equivalents, and alternatives, will become apparent to those skilled in the art once the above disclosure is fully appreciated. It is intended that the following claims be interpreted to embrace all such modifications, equivalents, and alternatives where applicable. Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

1. A curing process comprising:
providing a hybrid material comprising a conductive filler in contact with a thermosetting resin; and
passing an electric current through the hybrid material to provide Joule heating until a temperature of the hybrid material reaches a temperature above a curing temperature of the thermosetting resin.

2. The curing process of claim 1, wherein the conductive filler is selected from carbon fibers, carbon nanofibers (CNF), graphene particles, graphene nanoparticles, carbon black, metallic particles, metallic fibers, metallic meshes, or a combination thereof.

3. The curing process of claim 2, wherein the conductive filler comprises CNF, optionally produced via a method comprising hot drawing of precursor fibers.

4. The curing process of claim 3 further comprising forming the CNF, optionally by:
forming a plurality of precursor fibers, wherein the plurality of precursor fibers comprise a polymer;
drawing the plurality of precursor fibers at a drawing temperature, wherein the drawing temperature is above room temperature; and
subjecting the plurality of precursor fibers to a pyrolysis process after the drawing, whereby the polymer carbonizes to provide the CNF.

5. The curing process of claim 4:
wherein the polymer comprises polyacrylonitrile (PAN), polyvinylidene fluoride (PVDF), pitch and lignin, or a combination thereof;
wherein the pyrolysis process includes a pyrolysis temperature of greater than or equal to about 1400° C.;
wherein the drawing temperature is lower than the pyrolysis temperature and greater than or equal to the glass transition temperature (T_{g}) of the precursor fibers;
wherein forming the plurality of precursor fibers comprises electrospinning; and/or
wherein the precursor fibers comprise the polymer and another polymer, and wherein the another polymer decomposes during the pyrolysis process to form pores in the CNF.

6. The curing process of claim 2, wherein the conductive filler comprises a network of the CNF, and optionally:
wherein providing the hybrid material comprising the conductive filler in contact with the thermosetting resin comprises embedding the network of CNF in the thermosetting resin;
wherein the network of the CNF comprises a CNF mat; and/or
wherein providing the hybrid material comprising the conductive filler in contact with the thermosetting resin comprises sandwiching the CNF mat between a first fabric layer and a second fabric layer, wherein a side of the first fabric layer proximate the CNF mat, a side of the second fabric layer proximate the CNF mat, or both comprise the thermosetting resin distributed therein.

7. The curing process of claim 1, wherein the thermosetting resin is within a cured in place pipe (CIPP) liner.

8. The curing process of claim 1:
wherein the hybrid material comprises less than about 10 wt % of the conductive filler; wherein the hybrid material comprise greater than or equal to 0.1 wt % of the conductive filler;
wherein the curing temperature is in the range of from about 70° C. to about 160° C.;
wherein the hybrid material has an sheet resistance in the range of from about 1*10⁻⁵ to about 20*10⁻⁵ ohm-meter (Ω·m);
wherein passing an electric current through the hybrid material comprises providing an electrical current of less than or equal to about 1, 5, or 10 Amperes (A); and/or
wherein a voltage applied to the hybrid material during the curing process is in a range of from about 10 to about 200 volts (V) per meter length of the hybrid material.

9. A process comprising:
forming a plurality of precursor fibers, wherein the plurality of precursor fibers comprise a polymer;
drawing the plurality of precursor fibers at a drawing temperature above room temperature; and
subjecting the plurality of precursor fibers to a pyrolysis process after the drawing.

10. The process of claim 9:
wherein the pyrolysis process includes a pyrolysis temperature of greater than or equal to about 1400° C., and optionally, wherein the drawing temperature is less than or equal to the temperature of the pyrolysis process and greater than or equal to a glass transition temperature (T_{g}) of the precursor fibers;
wherein forming the plurality of precursor fibers comprises electrospinning;
wherein the polymer comprises polyacrylonitrile (PAN), polyvinylidene fluoride (PVDF), pitch, lignin, or a combination thereof;
wherein the precursor fibers comprise the polymer and another polymer, wherein the second polymer decomposes during the pyrolysis process to provide pores in the CNF, and optionally wherein the another polymer comprises polymethylmethacrylate (PMMA), polystyrene (PS) and/or silicon dioxide (SiO₂) or a combination thereof.

11. The process of claim 9 further comprising:
forming a plurality of carbon nanofibers (CNF) during the subjecting of the plurality of precursor fibers to the pyrolysis process after the drawing;
forming a network of the CNF;
contacting the network of the CNF with a thermosetting or thermoplastic resin to form a hybrid material; and
passing an electric current through the hybrid material.

12. The process of claim 11:
wherein the hybrid material comprises less than or equal to about 10 weight percent (wt %) of the CNF; and/or
wherein the hybrid material comprises greater than or equal to about 0.1 weight percent (wt %) of the CNF.

13. A hybrid material comprising a conductive filler in contact with a thermosetting resin or a thermoplastic resin, wherein the thermosetting resin or the thermoplastic resin is in contact with a flexible fabric, and wherein the hybrid material comprises from about 0.1 to about 10 weight percent (wt %) of the conductive filler,
wherein the hybrid material has a conductivity such that an electric current in a range of from about 0.1 to about 10 Amperes (A) can be passed through the hybrid material to provide Joule heating such that a temperature of the hybrid material reaches a temperature above a curing temperature of the thermosetting resin or a melting temperature of the thermoplastic resin whereby the thermosetting resin can be cured or the thermoplastic resin can be melted.

14. The hybrid material of claim 13, wherein the conductive filler comprises carbon nanofibers (CNF), and wherein the CNF optionally: have an aspect ratio of greater than or equal to about 1000, 5,000, or 10000, and/or a diameter of less than or equal to about 500, 400, 300, 200, or 100 nm, as a result of production thereof via: forming a plurality of precursor fibers via electrospinning, wherein the plurality of precursor fibers comprise a polymer; drawing the plurality of precursor fibers at a drawing temperature, wherein the drawing temperature is greater than or equal to the glass transition (T_{g}) temperature of the precursor fibers; and subjecting the plurality of precursor fibers to a pyrolysis process at a pyrolysis temperature after the drawing, whereby the polymer carbonizes to provide the CNF, wherein the pyrolysis temperature is greater than the T_{g} temperature.

15. The hybrid material of claim 13:
wherein the hybrid material comprises a cured in place pipe (CIPP) liner comprising a liner of the flexible fabric impregnated with the thermosetting resin and further comprising the conductive filler;
wherein the thermosetting resin comprises an epoxy resin, a vinyl ester resin, an unsaturated polyester resin, or a combination thereof;
wherein the flexible fabric can be stretched by at least 5, 10, or 15% from an initial length thereof; and/or
wherein the flexible fabric has a melting temperature greater than the curing temperature of the thermosetting resin and/or the melting temperature of the thermoplastic resin.
